(19) United States
(12) Patent Application Publication
(10) Pub. No.: US 2002/0032551 A1
(43) Pub. Date: Mar. 14, 2002

(54) Systems and methods for implementing hash algorithms

(76) Inventor: Jabari Zakiya, Hyattsville, MD (US)

Correspondence Address: Jabari Zakiya, 4506 South Dakota Ave. NE, Washington, DC, 20017, US

(21) Appl. No.: 09/922,779

(22) Filed: Aug. 7, 2001

Related U.S. Application Data
(60) Provisional application No. 60/223,316, filed on Aug. 7, 2000.

(51) Int. Cl. G06F 17/10

(52) U.S. Cl. 703/2

(57) ABSTRACT

The present invention describes methods and systems to perform hash algorithms as logic gate functions. It processes an N-bit block of data into the M-bit hash or message digest of the block in one (1) process cycle instead of the multiple cycles generally required. The minimum process time is the total propagation delay of an input block through the core logic for an implementing technology. A message requiring Y blocks to process would require no more than Y process (clock) cycles to produce the final hash value. This creates very simple and fast implementations of hash algorithms which enable them to be simply and easily integrated into any system.

This application claims the benefit of Provisional Application 60/223,316 of Jabari Zakiya filed Aug. 7, 2000 for METHOD FOR IMPLEMENTING THE SECURE HASH ALGORITHM AS A HARDWARE LOGIC GATE, the contents of which are incorporated herein.

### FIELD OF INVENTION

This invention relates to the field of data encryption, cryptographic hash algorithms, and more particularly to methods and symptoms for implementing cryptographic hash algorithms.

### BACKGROUND OF THE INVENTION

Hash functions are used to compute a unique condensed representation of a message or a data file. An input message of any length<2^{L} bits is processed to produce a M-bit message digest, or the hash, as the output. A cryptographic hash function is considered secure when it is computationally infeasible to find a message which corresponds to a given hash value, or to find two different messages which produce the same hash. Any change to a message in transit will, with very high probability, result in a different hash, causing the signature verification of that message to fail.

This invention describes a method for implementing the computational core of a hash algorithm non-sequentially. It processes an N-bit data block to create a M-bit message digest using only combinatorial logic. Thus, this invention describes a method for implementing hash algorithms which will create a hash for a block of data in one process (clock) cycle and also produce the hash of a Y-block long message in no more than Y process (clock) cycles.

The current most widely used hash algorithms are MD5 and the Secure Hash Algorithm (SHA-1), specified by the National Institute of Standards and Technology (NIST) in FIPS 180-1. Newer hashes SHA-256, SHA-384, and SHA-512, have also been specified in FIPS 180-2 by NIST. They differ primarily in the length of the hash value, ranging from 128-512 bits. An application of this invention's methodology herein will primarily focus on implementing these genetically related hashes. However, other hash algorithms, such as the RIPEMD family (also genetically related to the above algorithms), can be similarly decomposed into their generic structures and implemented.

A consequence of this invention's design philosophy causes a tradeoff between hardware resources (gates) for clock cycles (time). This enables algorithms to be implemented architecturally in the fastest manner possible. This creates many advantages over sequential devices. First, all external clocking circuitry is eliminated, making systems easier to design with, which use less parts. Thus, physical systems can be made smaller, which use less power and produce less heat, which increases their reliability, resulting in significant reductions in total system costs.

Even more important, this invention enables hash algorithms to meet the performance requirements of new Internet broadband rates, cell phones, and other highspeed usages. This will become increasingly important as the requirements for authentication, and the use of digital signatures, expand to meet the needs of e-commerce, secure financial transactions, secure e-mail, and other applications driven by privacy and security concerns,

### OBJECTS OF THE INVENTION

It is an object of the present invention to create a method to perform hash algorithms as logic gate functions using only combinatorial non-sequential logic.

Another object of the invention is to perform hash algorithms architecturally in the fastest manner.

Still another object of the invention is to create a method to perform hash algorithms which eliminates the need for external clocking circuitry.

A further object of the invention is to minimize a physical system's complexity and parts counts to perform hash algorithms.

Yet another object of the invention is to create the lowest power consuming and heat dissipating architectures for implementing hash function devices.

Still yet another object of the invention is to maximize a hash system's reliability.

Another object of the invention is to minimize total system costs to perform hashes.

Still a further object of the invention is to allow hash algorithms to be easily configurable in systems implementing the Digital Signature Standard and other cryptographic protocols.

Still another object of this invention is to produce simple HDL device models which can implement a hash algorithm in FPGA, ASIC, and VLSI designs, using various device technologies.

### SUMMARY OF THE INVENTION

It is therefore an object of the present invention to describe methods and systems to perform hash algorithms as logic functions comprised totally of non-sequential combinatorial logic. This is achieved through the creation of a non-sequential decomposition of a hash algorithm. This decomposition produces various embodiments of combinatorial logic elements which are simply connected together to perform the algorithm. This enables the creation of an architecture for performing hash algorithms in an extremely simple and fast manner.

### BRIEF DESCRIPTION OF THE DRAWINGS

The objects, features, and advantages of the present invention will be apparent from the detailed description of the preferred embodiments with references to the following drawings.

FIG. 1 is a block diagram of a generic architecture to perform hash algorithms.

FIG. 2 is a block diagram of the architectural structure for MD5.

FIG. 3 is the generic block structure of the round functions for MD5.

FIG. 4 is a block diagram of the architectural structure for SHA-1.

FIG. 5 is the generic block structure of the round functions for SHA-1.

FIG. 6 is a block diagram of the architectural structure for SHA-256/384/512.

FIG. 7 is the generic block structure of the round functions for SHA-256/384/512.

FIG. 8 lists the renamed nonlinear functions and their round usage.

FIG. 9 is the generic block structure of the multi-hash round functions for MD5/SHA-1.

FIG. 10 is a block diagram of a multi-hash structure to implement both MD5 and SHA-1.

### DETAILED DESCRIPTION

Hash algorithms typically involve two stages of processing. The first stage consists of creating message blocks of the required length, based on an algorithm's protocols. This includes performing block padding and inserting the bit count of the message into a block when necessary. The second stage consists of the hash computation. This invention describes methods and systems to perform the hash computation stage for hash algorithms.

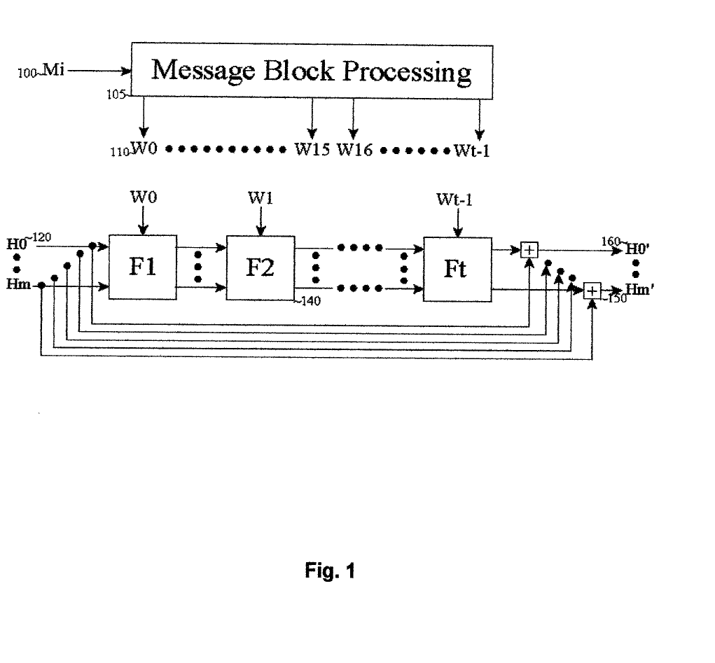

FIG. 1 is a generic block diagram of a hash algorithm. An N-bit message block Mi 100 is the input. For MD5 and SHA-1/256, a message block is 512-bits, while for SHA-384/512 its 1024-bits. The output hash value 160 of a message block consists of the values H₀′-Hₘ′. Full hash values range from 4 32-bit values (128-bits) for MD5, 5 32-bit values (160-bits) for SHA-1, 8 32-bit values (256-bits) for SHA-256, 6 64-bit values (384-bits) for SHA-384, and 8 64-bit values(512-bits) for SHA-512. While the hash is used as a contiguous bit value, it is usually produced as separate smaller bit sized words, typically called chaining values.

A message is hashed in the following manner. A message of any length<2^{L} bits (L is 64 or 128 for above hashes) is processed into message blocks of N-bits. Each message block Mi undergoes some processing, as shown in 105, to produce a message schedule 110, which consists of the values W₀-Wₜ₋₁. For MD5, this processing consists of merely splitting Mi into 16 32-bit words, while for the SHA family of hashes it involves more elaborate processing. These Wi are inputs into the round functions 140.

The round functions 140 also have as an input the intermediate hash values. Each 140 produces new intermediate output hash values for the number of rounds specified by the algorithm. The initial hash value 120 (H₀-Hₘ) is added at 150 to the last round's hash to produce the final hash value 160 for the message block Mi. This becomes the new initial hash value 120 for the next message block or the final hash value after the last block. The initial hash value for the first block is specified by the hash algorithm.

The round functions 140 perform various arithmetic and logic operations, which may also require the use of specified values other than the intermediate hash values and message schedule values. Also, the internal computational functions and structures will generally not be the same for each round. The rounds typically range from 64 (MD5 and SHA-256) to 80 (SHA-1/384/512).

The block structure of FIG. 1 has been traditionally implemented as a sequential clocked network, usually requiring at least as many clock cycles as rounds. This invention implements the structure of FIG. 1 by creating separate instantiations of the round functions and message block processing elements, which are then simply connected together.

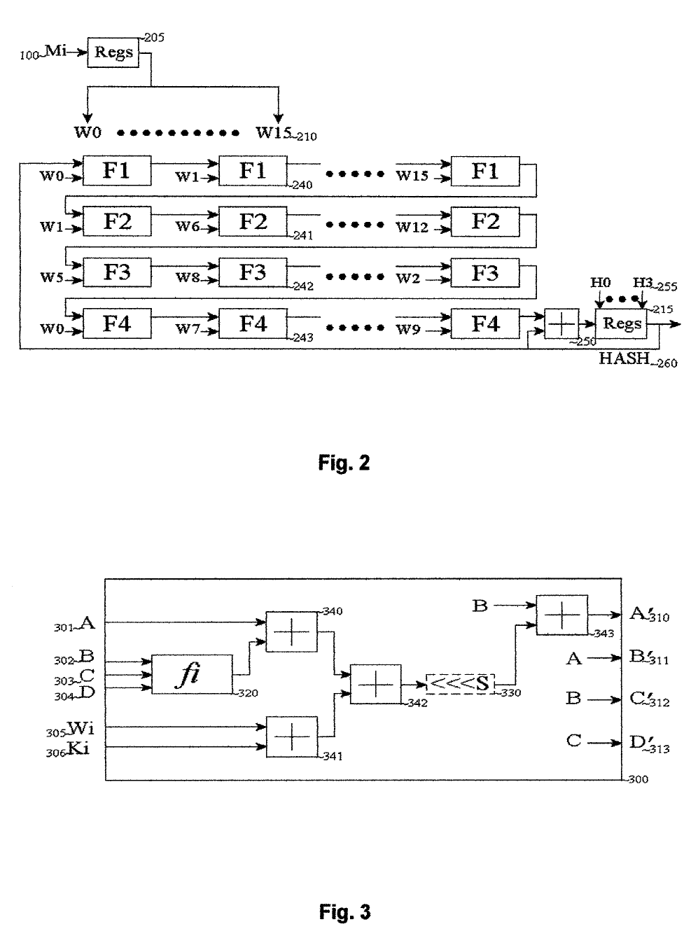

FIG. 2 shows the generic block structure for MD5. It requires 64 rounds consisting of the four distinct round functions 240-243 (F1-F4), each used for 16 rounds. Message block processing for MD5 consists of splitting Mi into 16 32-bit words 210 W0-W15. For each 16 round group, a different permutation of the Wi are inputs into each Fi. The initial hash value 255 (H0-H3) is used for the first (or only) block of a message, and becomes the first hash when the system is initialized for each message. The output HASH 260 is the final hash value for each Mi block.

FIG. 3 shows a generic structure for the MD5 round functions 240-243. The input hash is the 4 32-bit chaining values A-D 301-304 and the output hash is A′-D′ 310-313. Each round also has 32-bit input words Wi 305 and constant value Ki 306. MD5 specifies a different Ki for each round. The value S specifies the number of bits of rotation for the 32-bit left rotate operation 330. For F1 S=(1, 12, 17, 22), for F2 S=(5, 9, 14, 20), for F3 S=(4, 11, 16, 23) and for F4 S=(6, 10, 15, 21). These values are used every fourth round within the 16 round group for each function. The nonlinear function 320 is specified as ƒ₁(X, Y, Z)=[X AND Y] OR [˜X AND Z] for F1,ƒ₂(X, Y, Z)=[Z AND X] OR [˜Z AND Y] for F2,ƒ₃(X, Y, Z)=X XOR Y XOR Z for F3, and ƒ₄(X, Y, Z)=Y XOR [˜Z OR X] for F4. A round also performs 4 32-bit additions 340-343.

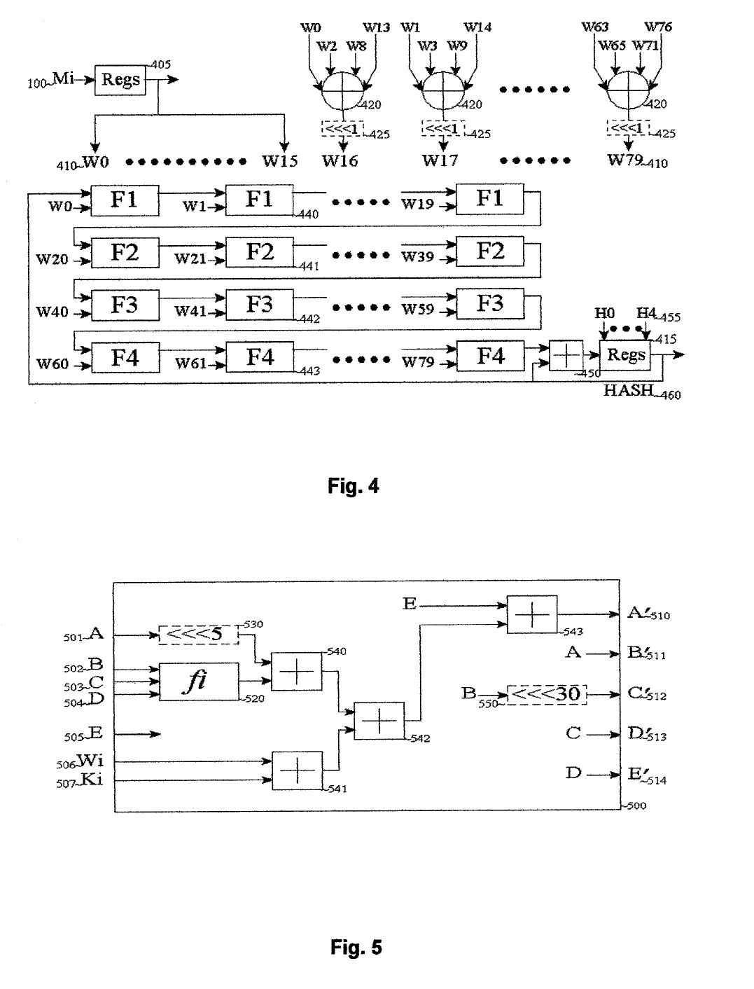

FIG. 4 shows the block structure for SHA-1. It performs 80 rounds using the four round functions 440-443, which are used for 20 rounds each. The message block Mi is, again, first split into 16 32-bit words W0-W15, where W0 is the beginning of a message block. These Wi are used to create 64 morel Wi defined as: for t=16 to 79 Wₜ=[(Wₜ₋₃XOR Wₜ₋₈XOR Wₜ₋₁₄XOR Wₜ₋₁₆)<<<1]. Element 420 is a 4-input 32-bit XOR function, while 425 is 1-bit left rotate operation (which requires no hard logic to perform) and is the revision to the original SHA specification. The initial hash value 455 (H0-H4) is used for the first (or only) Mi of a message, and is the first hash when a system is initialized. The output HASH 460 is the final hash value for each Mi.

FIG. 5 shows the generic round structure for SHA-1. The input hash is the five chaining values A-E 501-505, and the output hash A′-E′ 510-514, where A is the first (most significant) 32-bit word of the hash value. The 32-bit words Wi 506 and Ki 507 are also inputs. SHA-1 specifies only four Ki constants, one for each Fi. It also specifies two fixed 32-bit left rotate operations 530 and 550. The nonlinear function 520 is specified as ƒ₁(X, Y, Z)=[X AND Y] OR [˜X AND Z] for F1, ƒ₂(X, Y, Z)=XXOR Y XOR Z for F2, ƒ₃(X, Y, Z)=[X AND Y] OR [X AND Z] OR [Y AND Z] for F3, and ƒ₄(X, Y, Z)=X XOR Y XOR Z for F4. Four 32-bit additions 540-543 are also performed.

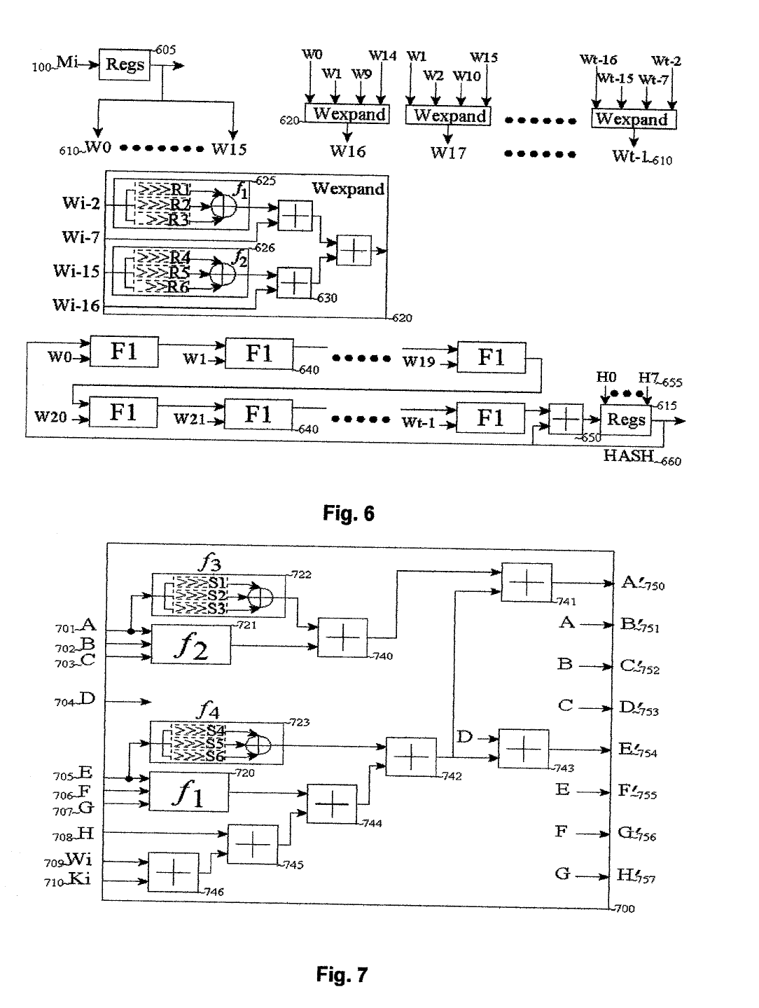

FIG. 6 shows the generic block structure for SHA-256/38/512. SHA-256 has t=64 rounds, while SHA-384/512 has 80. There is now just one generic round function F1 640. Message block processing produces 64 or 80 Wi. Mi is first split, again, into W0-W15, where each Wi is 32-bits for SHA-256 and 64-bits for SHA-384/512. These Wi are used to create the additional Wi by the plurality of expansion elements Wexpand 620. These use functions 625 ƒ₁ and 626 ƒ₂, which have the generic structure ƒ1(Wi)=ROTR(Ri) XOR ROTR(Rj) XOR SHR(Rk). The R variables indicate how many bits input Wi is rotated (>>>) or shifted (>>) right in each instance. For ƒ₁ the R-tuples are (R1, R2, R3)=(3|1, 7, 18|8) for SHA-256|[384/52], and for ƒ₂ the R-tuples are (R4, R5, R6)=(10|6, 19, 17|61). Three 2^{b}-bit additions 630 are also performed. The Wi are used in ascending order as inputs into the round functions F1. The initial hash values 655 are either 32 or 64 bits wide, depending on the algorithm, and are different for each algorithm. The intermediate hashes are computed using all 8 chaining values A-H, but for SHA-384-the final hash is just the first 6 chaining values A-F, otherwise the algorithms are structurally identical.

The generic block structure for 640 is shown in FIG. 7. The inputs are the eight chaining values A-H 701-708, as well as Wi 709 and Ki 710, while the output is the hash A′-H′ 750-757. Unique Ki constants are specified for each round for each algorithm. The nonlinear functions 720-723 are ƒ₁(X, Y, Z)=[X AND Y] OR [˜X AND Z], ƒ₂(X, Y, Z)=[X AND Y] XOR [X AND Z] XOR [Y AND Z], ƒ₃(X)=ROTR(S1) XOR ROTR(S2) XOR ROTR(S3), and ƒ₄(X)=ROTR(S4) XOR ROTR(S5) XOR ROTR(S6). For SHA-256 and [384/512], these S-tuples are (S1, S2, S3)=(2|28, 13|34, 22|39) for ƒ₃ and (S4, S4, S6)=(6|14, 11|18, 25|41) for ƒ₄. Seven 2^{b}-bit additions 740-746 are also performed, where b is either 32 or 64.

Each of these algorithms can be implemented separately as a physical device by constructing the necessary round functions, constant values, and message processing elements, and connecting them as required. The methodology of this invention also enables systems which can perform multiple hash algorithms to be designed with a minimum set of common computational elements. Thus, for example, systems needing both MD5 and SHA-1 (required for the Digital Signature Standard), and/or SHA-256, etc, can be efficiently implemented. This can be accomplished because these algorithms can be decomposed into a few common computational elements which can be used to implement them non-sequentially in a cohesive system architecture.

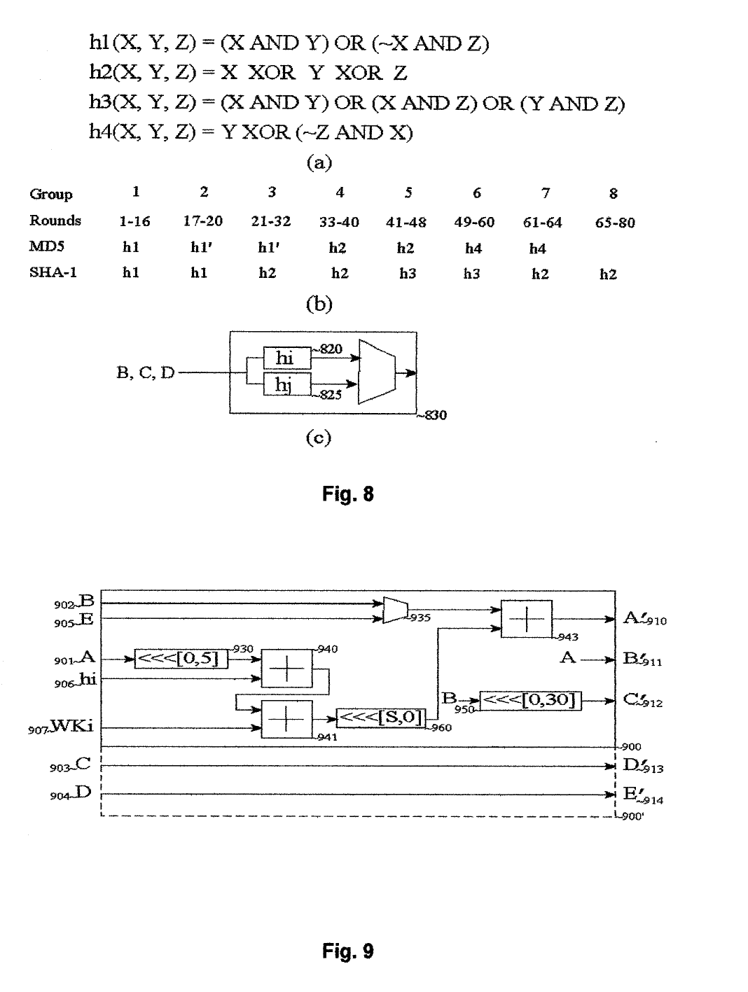

A first step in this process is to identify as many common structures and elements as possible, first at the highest structural level, then down to lower levels. One output of this process is the recognitions that there are only four distinct nonlinear functions which can be shared between MD5 and SHA-1. The functions ƒ₁ and ƒ₂ for MD5 and ƒ₁ or SHA-1 are structurally identical and can be shared. MD5's ƒ₃ and ƒ₂ and ƒ₄ for SHA-1, are also identical. Thus, the four common nonlinear functions can be renamed to h₁(X, Y, Z)=[X AND Y] OR [X AND Z], h₂(X, Y, Z)=XXOR Y XOR Z, h₃(X, Y, Z)=[X AND Y]OR [X AND Z] OR [Y AND Z], and h₄(X, Y, Z)=Y XOR [˜Z OR X]. FIG. 8(a) shows these four renamed nonlinear functions.

A next step is to identify for which round these nonlinear functions are used. FIG. 8(b) maps the use of each h for each algorithm for different round groups. It shows there are 8 distinct round groupings. For Group 1 h1 is common to both algorithms, and for Group 4 h2 is common. For rounds 65-80 (Group 8) only h2 is used, for SHA-1. For round Groups 2,3,5-7, a switching network 830 routes the selected output from the nonlinear function pair 820 hi or 825 hj, whose inputs are the correctly routed chaining values B, C, and D, to a round function. In 830 hi and hj represent the appropriate nonlinear functions for a Group, for MD5 and SHA-1.

An additional design partitioning optimization is achieved by removing the (Wi+Ki) additions from the round functions and performing them instead in the message processing block. FIG. 9 shows a new simplified round function 900 which is used to perform both SHA-1 and MD5. The inputs consists of the chaining values A, B, and E, hi 906 (the output of 830), and WKi 907, the (Wi+Ki) sum for the round. The current C and D chaining values are merely renamed and routed for use in the next round, as shown by 900′. The outputs are the new chaining values A′-C′ 910-913, though B′ is just the renamed A chaining value. A multiplexor 935 selects B or E to be added at 943. The elements 930, 950, and 960 represent the logic to perform the necessary rotate operations for each hash. This round function structure (with the rotates hardwired for each hash) can also produce better delay times when each hash is implemented separately.

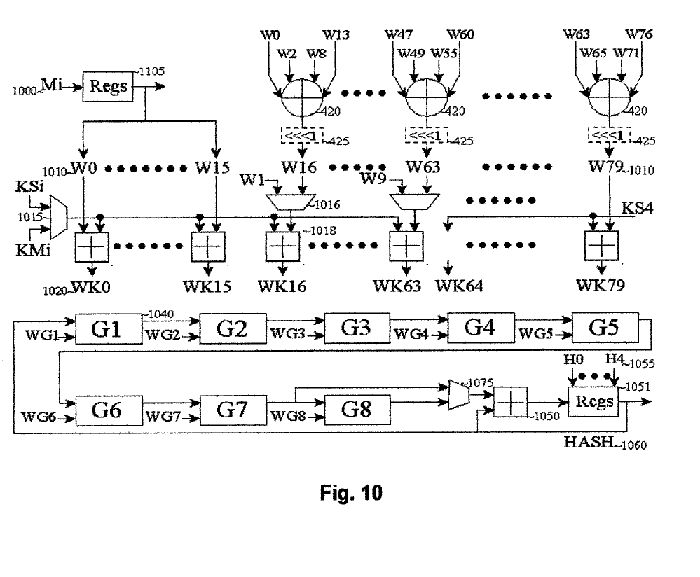

FIG. 10 is a generic structure to implement both SHA-1 and MD5 in one system. Message block processing now performs the additions of Wi and Ki, along with the creation and multiplexing of the Ki constants. Multiplexor 1015 represents the selection and routing of the Ki constants to the 1018 adders for each hash for the first 64 rounds. The last 16 WKi words use KS4 for SHA-1. Now for t total rounds, the WKi 32-bit words 1020 are created and routed to the round functions. Each Gi 1040 performs the number of rounds shown in 8(b), which are implemented with elements 830 and 900. For each Gi rounds group the appropriate hi functions are used in the 830 elements, and the WGi inputs are the required WKi. The system output, selected by multiplexor 1075, will be the A-D chaining values from Group 7 for MD5, or the last A-E chaining values from round 80 when SHA-1 is selected.

Design and Performance Issues

The “best” decomposition and partitioning of an algorithm for implementing as a real device will be determined by several parameters. While this invention describes a non-sequential methodology to make hash devices and systems, which is inherently faster than sequential design methodology, design optimization tradeoffs will still exist and must be recognized to create the best structures to implement. Depending on the performance requirements, some design choices will be better than others for a specific implementing technology and device architecture.

Generally though, reducing the length of the input-to-output critical delay path (cdp) through a system is a standard design goal. Reducing the cdp through a system minimizes its total propagation delay (tpd), which maximizes its speed. Thus, a design goal for implementing a real device seeks to make the elements that comprise the cdp to be as physically “small” or “thin” as possible so they can be placed as close together as possible. Also, another goal is to minimize the intra-component wire routing requirements. As device technologies produce physically smaller gates the wiring and routing delays become more dominant, and critical to control.

In FIG. 9 the purpose of removing the adder out of the round function was to reduce its size (area), which decreases its cdp length, thus lowering its tpd. This also reduces the input data lines into each round function, enabling them to be placed physically closer together, which reduces the intra-round routing delay, further reducing the tpd of the entire system. Thus in FIG. 10, the components that compute the Wi/WKi constant values are all logically grouped in one block. When building a real device, these components can then be placed and routed separately from the round function components, which have the highest priority performance routing requirements.

The round functions for these hash algorithms have two critical delay paths: the input hash-to-output hash path and the Wi (or WKi)-to-output hash path. For the first round function, the initial hash values are always present before an input block Mi is loaded into the system. Thus, the cdp for the first round is the W0/WK0-to-output hash path, because until the propagation delay caused by input W0/WK0 through the first round logic stabilizes, the output hash will not become stable. Specifically, the A′ chaining value will always take the longest time to stabilize for any round.

However, after the first round, the cdp through each round will be the input hash-to-output hash path, specifically the A-to-A′ path. This occurs because after the first round the Wi/WKi values for all the other rounds become stable inputs into those round functions before the input hash values becomes stable into those rounds. Thus, the propagation path of the input hash through the round logic, to become a stable output hash value, becomes the cdp. Therefore, a device or system can be fully characterized for performance by measuring the Mi/WK0-to-last A′ propagation delay. The design structure of FIG. 10, then, should be the optimal implementation because it enables physically smaller and thinner round functions and it reduces the wire routing into the rounds.

It can be seen from FIGS. 6 and 7 it is extremely simple to build a device to implement both SHA-384 and 512. The structures are identical, requiring only the addition of switching components to select the correct constants and rotate/shift parameters for each algorithm.

In general, any hash algorithm that can be implemented sequentially can be implemented using the methodology of this invention. This includes a methodology for achieving an “optimum” implementation of a hash algorithm for specific implementing technologies. This invention also presents a structured methodology for implementing multi-hash devices and systems.

What is claimed is:

1. A method for designing a device or system capable of:
implementing a hash algorithm which can generate the hash of an input message block using only non-sequential structures and logic elements which perform the plurality of the intermediate stage computations and logical operations of a hash algorithm without the use of a clock;

2. A device or system using the methodology of claim 1 capable of;
generating the full hash of an N-block long message in no more than N-process (clocks) cycles.

3. A device or system using the methodology of claim 1 wherein;
the total propagation delay through a critical delay path specifies the speed of a system or device.

4. An apparatus built using the methodology of claim 1 wherein:
a system or device manifested in an implementing technology is the physical expression of the design methodology of such a system or device.

5. An apparatus as claimed in claim 4;
can be built to implement any hash algorithm.
